(19) United States
(12) Patent Application Publication
(10) Pub. No.: US 2020/0023683 A1
(43) Pub. Date: Jan. 23, 2020

(54) VEHICLE WHEEL

(71) Applicant: HONDA MOTOR CO., LTD., Tokyo (JP)

(72) Inventors: Youichi KAMIYAMA, Wako-shi (JP); Toshinobu SAITO, Wako-shi (JP); Yusuke OSAWA, Wako-shi (JP)

(21) Appl. No.: 16/510,294

(22) Filed: Jul. 12, 2019

(30) Foreign Application Priority Data
Jul. 17, 2018 (JP) 2018-133910

(51) Int. Cl. B60B 21/12; G10K 11/175

(52) U.S. Cl. CPC B60B 21/12; G10K 2210/32272; B60B 2900/133; G10K 11/175

(57) ABSTRACT

In a vehicle wheel including a sub-air chamber member serving as a Helmholtz resonator, the sub-air chamber member is disposed in a tire air chamber with being supported by an air valve. The sub-air chamber member is connected to the air valve via a bracket, and the bracket is insert-molded in the sub-air chamber member. Alternatively, the sub-air chamber member is supported by the air valve via a support member. In this structure, the support member supports the sub-air chamber member so as to surround circumference of the sub-air chamber member, or has a gripping part nearly of a channel shape that grips the sub-air chamber member.

### CROSS-REFERENCE TO RELATED APPLICATION

This application is based upon and claims priority from the Japanese Patent Application No. 2018-133910, filed on Jul. 17, 2018, the entire contents of which are incorporated herein by reference.

### BACKGROUND OF THE INVENTION

### 1. Field of the Invention

The present invention relates to a vehicle wheel.

### 2. Description of the Related Art

As conventional art, there is known a vehicle wheel having a Helmholtz resonator disposed on an outer circumferential surface of a well part of a rim (see, e.g., Patent document 1: Japanese Unexamined Patent Application Publication No. 2012-45971). The vehicle wheel disclosed in Patent document 1 has configuration in which vertical walls are formed on the outer circumferential surface of the well part so as to extend in the wheel circumferential direction and the Helmholtz resonator is locked to grooves formed on the vertical walls. The vehicle wheel thus configured makes it possible to easily carry out mounting of the Helmholtz resonator on the rim.

However, the conventional vehicle wheel (see, e.g., Patent document 1) requires cutting and forming at least a pair of grooves on the rim for realizing a mounting structure of the Helmholtz resonator, thus posing a problem in that a manufacturing cost is increased. Accordingly, a vehicle wheel has been demanded which uses an existing structure of the wheel in mounting of the Helmholtz resonator.

The present invention has therefore been made in view of the above problem, and an object of the invention is to provide a vehicle wheel that makes it possible to use an existing structure of the wheel in mounting of a Helmholtz resonator to reduce a manufacturing cost.

### SUMMARY OF THE INVENTION

In order to attain the above object, according to an aspect of the present invention, a vehicle wheel reflecting one aspect of the present invention includes a sub-air chamber member serving as a Helmholtz resonator, wherein the sub-air chamber member is disposed in a tire air chamber with being supported by an air valve.

The vehicle wheel reflecting one aspect of the present invention makes it possible to use an existing structure of the wheel in mounting of a Helmholtz resonator to reduce a manufacturing cost.

### BRIEF DESCRIPTION OF THE DRAWINGS

The features and advantages provided by one or more embodiments of the invention will become apparent from the detailed description given below and appended drawings which are given only by way of illustration, and thus are not intended as a definition of the limits of the present invention.

FIG. 1 is a perspective view of a vehicle wheel according to an embodiment of the present invention.

FIG. 2 is an overall perspective view of a sub-air chamber member.

FIG. 3 is a sectional view taken along the line in

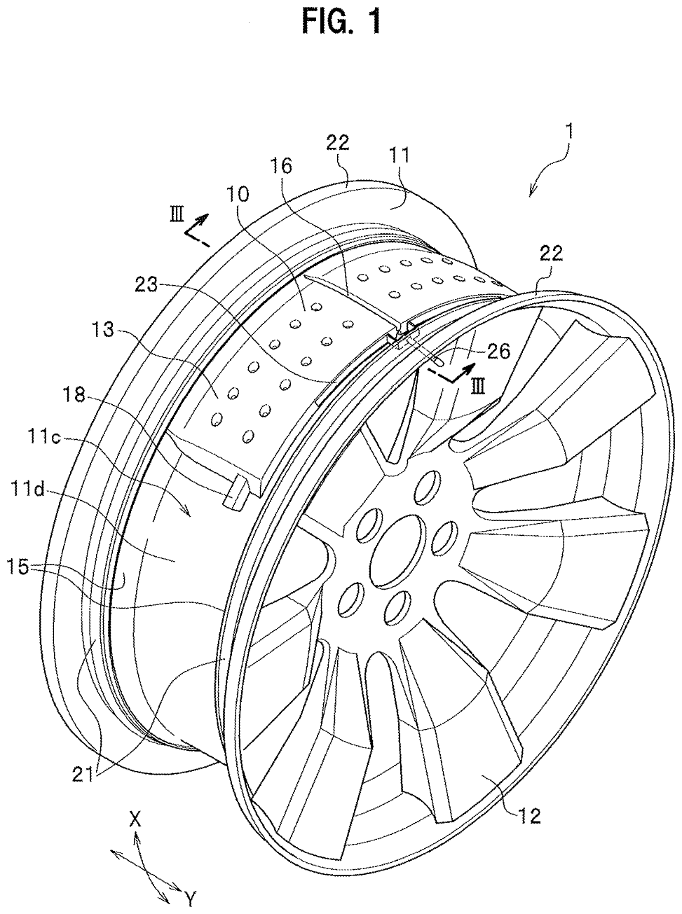

FIG. 1.

FIG. 4 is a perspective view of a support member that supports the sub-air chamber member.

FIG. 5 is a sectional view illustrating a modification of the support member that supports the sub-air chamber member.

FIG. 6 is a sectional view illustrating a modification of the mounting structure of the sub-air chamber member.

### DETAILED DESCRIPTION OF THE PREFERRED EMBODIMENTS

Hereinafter, vehicle wheels according to embodiments of the present invention will be described in detail with reference to the drawings as appropriate. Note that in the drawings to be referred to, reference sign “X” denotes a wheel circumferential direction; reference sign “Y” denotes a wheel width direction; and reference sign “Z” denotes a wheel radial direction. Moreover, in the wheel width direction Y, the center side on an outer circumferential surface of a well part in the wheel is referred to as “an inner side in the wheel width direction Y” and a rim flange side in the wheel is referred to as “an outer side in the wheel width direction Y”.

The vehicle wheels according to the embodiments each allow a sub-air chamber member serving as a Helmholtz resonator to be mounted on a rim via an air valve.

### <Overall Structure of Vehicle Wheel>

FIG. 1 is a perspective view of a vehicle wheel 1 according to an embodiment of the present invention.

As shown in FIG. 1, the vehicle wheel 1 according to the present embodiment assumes that it is made of light metal such as aluminum alloy and magnesium alloy. In FIG. 1, reference sign 12 denotes a disk for connecting a rim 11 to a hub (not shown).

The rim 11 includes a well part 11c that is recessed toward a wheel shaft side in the wheel radial direction between bead seats 21 formed on both end parts of the rim 11 in the wheel width direction Y. An outer circumferential surface 11d of the well part 11c is defined by a bottom face of the recessed part and has substantially the same diameter on the wheel shaft throughout the wheel width direction Y.

The rim 11 is provided with a pair of vertical walls 15 each rising from one of both end parts in the wheel width direction Y on the outer circumferential surface 11d of the well part 11c toward a rim flange 22 side. Moreover, the rim 11 rises at the outer side in the wheel width direction Y of the vertical walls 15, via the bead seats 21 to the rim flanges 22.

In FIG. 1, reference sign 10 denotes a sub-air chamber member serving as a Helmholtz resonator, and reference sign 26 denotes an air valve.

<Sub-Air Chamber Member>

Next, the sub-air chamber member 10 will be described.

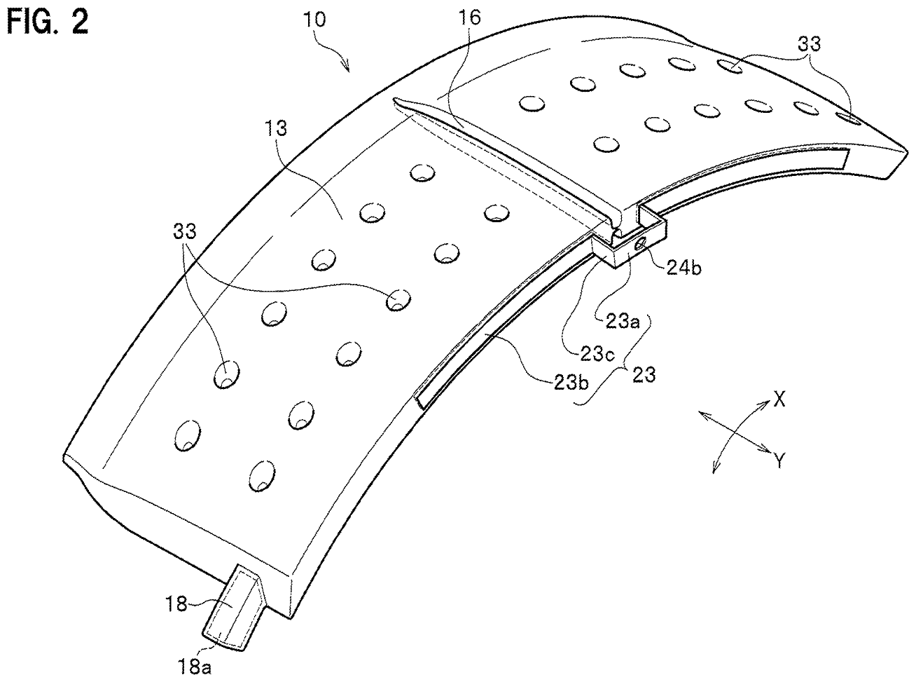

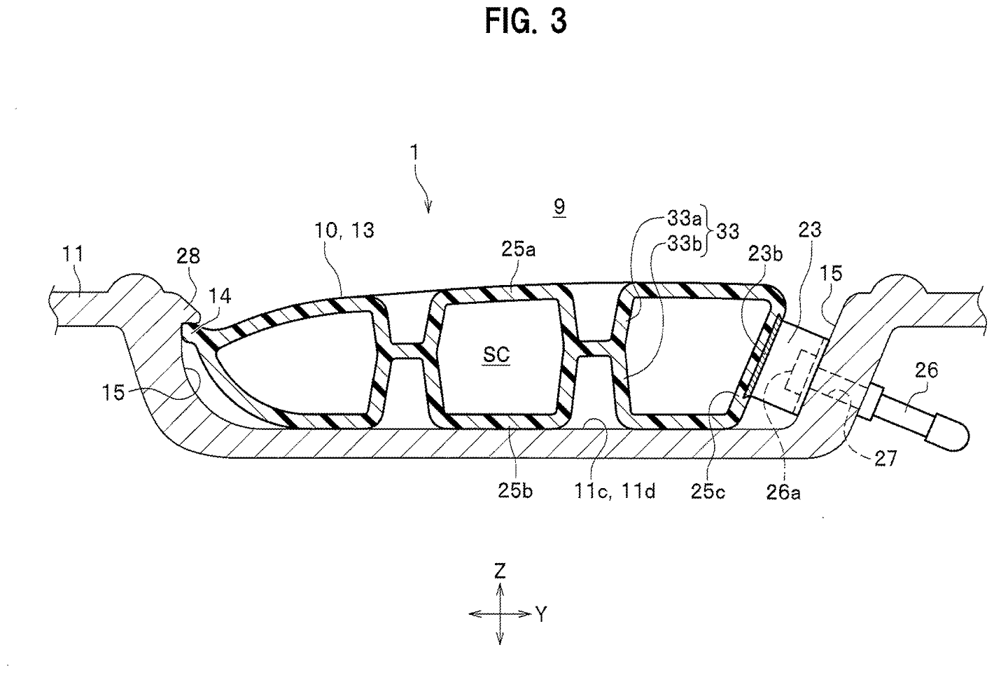

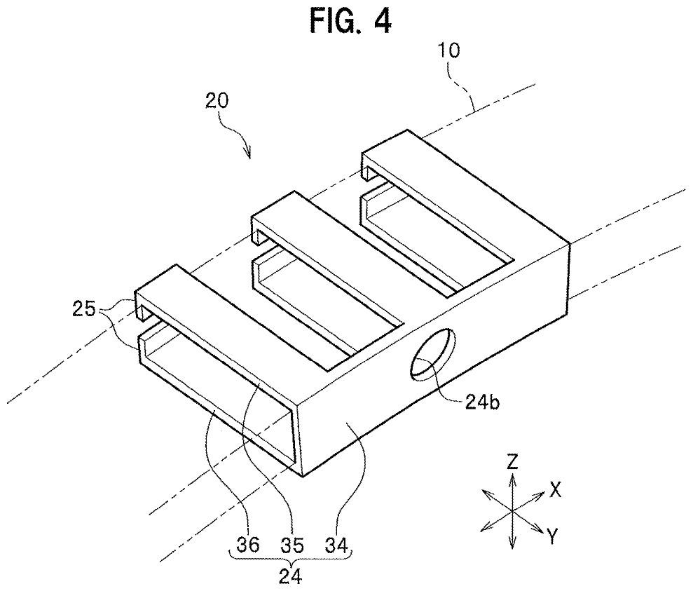

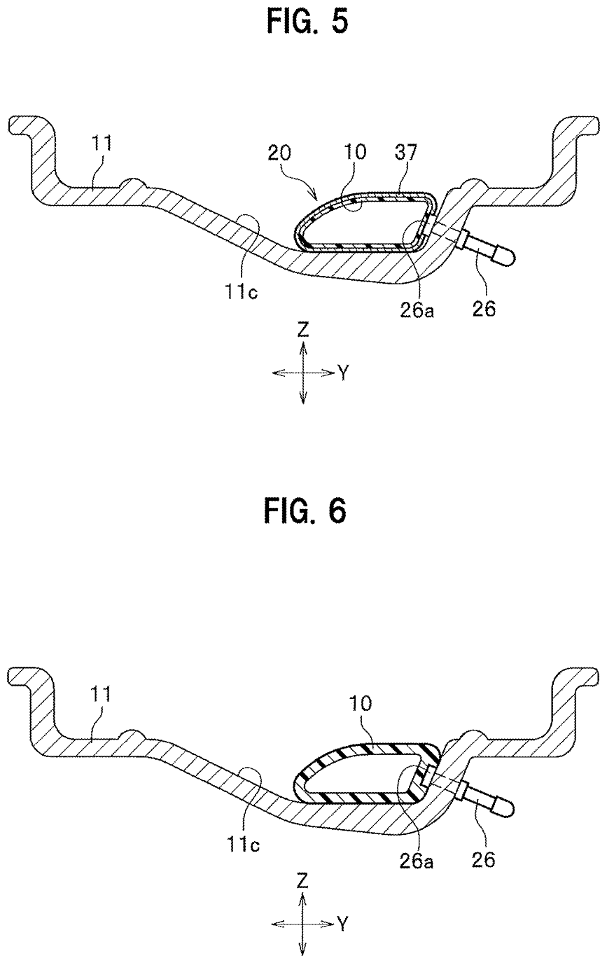

FIG. 2 is an overall perspective view of the sub-air chamber member 10. FIG. 3 is a sectional view taken along the III-III line in FIG. 1.

As shown in FIG. 2, the sub-air chamber member 10 is a member elongated in the wheel circumferential direction X and includes a main body 13 and a tubular body 18. Note that the sub-air chamber member 10 in the present embodiment assumes a resin molded form.

The sub-air chamber member 10 is configured to have a symmetric shape in the wheel circumferential direction X with respect to a partition wall 16 that extends in the wheel width direction Y at the center of the main body 13.

The main body 13 is curved in a longitudinal direction thereof. In other words, the main body 13 is configured to follow the wheel circumferential direction X when the sub-air chamber member 10 is disposed on the well part 11c (see FIG. 1).

The main body 13 has a hollow part inside. The hollow part (not shown) forms a sub-air chamber SC (see FIG. 3) as described later. The hollow part is divided by the partition wall 16 into two parts in the wheel circumferential direction X.

Moreover, the main body 13 is provided with a bracket 23. The bracket 23 is formed of a plate material that is bent, or an integral cast product made of metal. The bracket 23 extends in the wheel circumferential direction X so as to stride across an end part of the partition wall 16 on a side face of the main body 13, which is on the disk 12 (see FIG. 1) side.

The bracket 23 in the present embodiment is composed of base end parts 23b, leg parts 23c and a translation part 23a, and has a nearly hat shape in top view.

The base end parts 23b each corresponding to the flange having a nearly hat shape are half-embedded by insert-molding in the side plate 25c (see FIG. 3) of the main body 13 as described later. That is, surfaces of the base end parts 23b are exposed to the side plate 25c of the main body 13. Moreover, the leg parts 23c each corresponding to the side of a high-crowned part having a nearly hat shape, and the translation part 23a corresponding to the top of the high-crowned part, protrude from the side plate 25c. That is, the leg parts 23c protrude from the main body 13 in the wheel width direction Y, thereby allowing the translation part 23a to extend in the wheel circumferential direction X at a predetermined distance from the side face of the main body 13.

The translation part 23a has a locking hole 24b formed in the center thereof, with which a head part 26a (see FIG. 3) of the air valve 26 is engaged.

As shown in FIG. 3, the main body 13 is formed to be flat in the wheel width direction Y, in cross section orthogonal to the longitudinal direction (the wheel circumferential direction X in FIG. 2).

More specifically, the main body 13 includes a bottom plate 25b that adjoins the outer circumferential surface 11d of the well part 11c and extends in the wheel width direction Y, and an upper plate 25a disposed so as to face the bottom plate 25b above the outer circumferential surface 11d. Moreover, the main body 13 includes a sideplate 25c that rises from an edge in the wheel width direction Y of the bottom plate 25b to be joined to the upper plate 25a, at the side where the air valve 26 is disposed.

The side plate 25c is in nearly parallel with the vertical wall 15 on which the air valve 26 is mounted. Incidentally, in the side plate 25c, the base end parts 23b of the bracket 23 described above are half-embedded.

Moreover, the main body 13 includes an edge 14 located at an opposite side in the wheel width direction Y to the air valve 26. The edge 14 is formed into a plate shape by joining edges of the upper plate 25a and the bottom plate 25b of the sub-air chamber member 10 together and projects outward in the wheel width direction Y. The edge 14 extends in the wheel circumferential direction X (see FIG. 1).

Thus, the upper plate 25a, the bottom plate 25b and the side plate 25c are formed to surround the sub-air chamber SC inside the main body 13.

Moreover, as shown in FIG. 2, the main body 13 has a plurality of bridges 33 formed to be arranged at equal intervals in the wheel circumferential direction X. Moreover, the bridges 33 are arranged in two rows in the wheel width direction Y.

As shown in FIG. 3, the bridges 33 are each formed with an upper side connecting part 33a and a lower side connecting part 33b being joined together at a nearly central position between the upper plate 25a and the bottom plate 25b.

Note that the upper side connecting part 33a is formed so as to allow the upper plate 25a to be partially recessed toward the bottom plate 25b. Moreover, the lower side connecting part 33b is formed so as to allow the bottom plate 25b to be partially recessed toward the upper plate 25a.

The bridge 33 thus formed has a nearly cylindrical shape and partially connects the upper plate 25a with the bottom plate 25b. Moreover, the bridge 33 forms circular openings in planar view at corresponding positions in the up-down direction of the main body 13.

Next, the tubular body 18 (see FIG. 1) will be described. Next, the tubular body 18 (see FIG. 1) will be described.

As shown in FIG. 1, the tubular body 18 is formed so as to protrude from the main body 13 in the wheel circumferential direction X at a position biased to one side in the wheel width direction Y on the main body 13.

The sub-air chamber member 10 in the present embodiment is formed, as described above, into a symmetric shape in the wheel circumferential direction X with respect to the partition wall 16. Accordingly, although only one tubular body 18 is shown in FIG. 1, the tubular bodies 18 in the present embodiment are disposed to form one pair at positions symmetrical to each other on both end parts in the longitudinal direction (the wheel circumferential direction X) of the main body 13. Incidentally, the tubular bodies 18 forming the pair in the present embodiment are spaced from each other in the circumferential direction at an angle of approximately 90 degrees around the wheel shaft as the center.

As shown in FIG. 2, the tubular body 18 has a communication hole 18a formed inside.

The communication hole 18a allows the sub-air chamber SC (see FIG. 3) formed inside the main body 13 to be communicated with a tire air chamber 9 (see FIG. 3) which is to be formed between the well part 11c (see FIG. 3) and a tire (not shown).

Although the sub-air chamber member 10 thus configured in the present embodiment assumes a resin molded form as described above, it is not limited to the resin molded form, but may be formed of other materials such as metal.

As shown in FIG. 3, the air valve 26 is press-fitted from the tire air chamber 9 side into a valve inserting hole 27 that is bored in the vertical wall 15 on the disk 12 side, and fixed on the rim 11 with a metal fixture (not shown). The air valve 26 in the present embodiment assumes a bolt fastening-type air valve, but may be substituted by a snap-in valve. Although not shown in the figure, the air valve 26 is provided with a valve cap and a body having a valve stem coated by rubber. Moreover, an annular recess of the air valve is formed at a base of the body. The valve inserting hole 27 is fitted into the annular recess of the air valve, thereby securing an air seal.

The head part 26a of the air valve 26, which is disposed on the tire air chamber 9 side, is connected via a stopper (not shown) to the locking hole 24b (see FIG. 2) of the bracket 23.

This allows the sub-air chamber member 10 to be fixed on the rim 11 via the bracket 23 and the air valve 26.

Moreover, the sub-air chamber member 10 allows the edge 14 thereof to be locked to the underside of an overhanging part 28 of the well part 11c.

Mounting of the sub-air chamber member 10 thus configured onto the rim 11 is carried out as follows. First, the air valve 26 is assembled with the bracket 23 of the sub-air chamber member 10. Next, an integrated object composed of the sub-air chamber member 10 and the air valve 26 is inclined with the air valve 26 side being directed downward, and the air valve 26 is inserted into the valve inserting hole 27. Then, the edge 14 side of the integrated object is pressed by a predetermined pusher to the well part 11c side, and the edge 14 having abutted on the overhanging part 28 is elastically deformed to be fitted into the underside of the overhanging part 28. This allows mounting of the sub-air chamber member 10 on the rim 11 to be completed.

Next, description will be given of operation and effects of the vehicle wheel 1 according to the present embodiment.

As described above, the conventional vehicle wheel (see, e.g., Patent document 1) requires cutting and forming a pair of grooves for a pair of edges on the rim in mounting of the sub-air chamber member.

In contrast, the vehicle wheel 1 according to the present embodiment allows one side part in the wheel width direction Y of the sub-air chamber member 10 to be connected to the rim 11 via the air valve 26 which is an existing structure of the wheel. Moreover, the other side part of the sub-air chamber member 10 is locked to the well part 11c via the edge 14.

That is, the vehicle wheel 1 in the present embodiment makes it possible to omit one of the pair of grooves as compared to the conventional vehicle wheel (see, e.g., Patent document 1).

Accordingly, the vehicle wheel 1 makes it possible to reduce a manufacturing cost as compared to the conventional vehicle wheel.

Moreover, the vehicle wheel 1 allows the strength of mounting of the sub-air chamber member 10 on the rim 11 to be enhanced as compared to a case where the sub-air chamber member 10 is cantilever supported on the rim 11 via the air valve 26 alone.

Moreover, the vehicle wheel 1 in the present embodiment allows the bracket 23 to be insert-molded in the sub-air chamber member 10.

The vehicle wheel 1 having the sub-air chamber member 10 thus configured makes it possible to mold the bracket 23 per se beforehand, thus allowing a degree of freedom in design of the bracket 23 to be greatly improved.

Although the embodiment of the present invention has been described above, the present invention is not limited to the above embodiment and can be put into practice in various forms.

Although, in the above embodiment, description has been given of the configuration in which the sub-air chamber member 10 is fitted to the air valve 26 via the bracket 23 insert-molded in the sub-air chamber member 10, the present invention is not limited to this embodiment. The present invention may adopt configuration such that the sub-air chamber member 10 is supported by the air valve 26 via a support member 20 (see FIG. 4) that is fitted to the air valve 26.

FIG. 4 is a perspective view of the support member 20 that supports the sub-air chamber member 10. Note that in FIG. 4, a shape of the sub-air chamber member 10 is schematically shown by a virtual line (two-dot chain line).

As shown in FIG. 4, the support member 20 is provided with an elongated base plate 34 that extends in the wheel circumferential direction X along the side face of the sub-air chamber member 10, and an upper side extending plate 35 and a lower side extending plate 36 that extend in the wheel width direction Y from upper and lower edges of the base plate 34, respectively.

The base plate 34 has a locking hole 24b provided in the center thereof in the wheel circumferential direction X, to which the head part 26a (see FIG. 3) of the air valve 26 is locked.

The upper side extending plate 35 and the lower side extending plate 36 formed integrally with the base plate 34 compose a gripping part 24 nearly of a channel shape in cross section orthogonal to the wheel circumferential direction X. Although not shown in the figure, multiple (in the present embodiment, three) gripping parts 24 are arranged in the wheel circumferential direction X.

Moreover, the upper side extending plate 35 and the lower side extending plate 36 each have nail plates 25 at tips thereof extending from the base plate 34 side, the nail plates 25 extending to face each other between the upper side extending plate 35 and the lower side extending plate 36.

The support member 20 thus formed allows the base plate 34 to be fixed via the locking hole 24b to the air valve 26 (see FIG. 3) and allows the upper side extending plate 35 and the lower side extending plate 36 of the gripping part 24 to sandwich the sub-air chamber member 10 between them to grip the sub-air chamber member 10.

The vehicle wheel 1 (see FIG. 1) with the support member 20 thus configured makes it possible to fix the sub-air chamber member 10 detachably on the rim 11 via the air valve 26.

Moreover, configuration can also be adopted such that the support member 20 supports the sub-air chamber member 10 so as to surround circumference of the sub-air chamber member 10.

FIG. 5 is a sectional view illustrating a modification of the support member 20 that supports the sub-air chamber member 10.

As illustrated in FIG. 5, the support member 20 according to the modification can be composed of an annular band-shaped member 37 that is attached to the head part 26a of the air valve 26 so as to surround circumference of the main body 13 of the sub-air chamber member 10.

The sub-air chamber member 10 is put into the band-shaped member 37 in the wheel circumferential direction X, thereby being fixed on the rim 11 via the air valve 26.

The vehicle wheel 1 (see FIG. 1) with the support member 20 thus configured makes it possible, with simple structure, to fix the sub-air chamber member 10 detachably on the rim 11 via the air valve 26.

FIG. 6 to be next referred to is a sectional view illustrating a modification of the mounting structure of the sub-air chamber member 10.

As illustrated in FIG. 6, the mounting structure of the sub-air chamber member 10 according to this modification has configuration such that a recess is formed on a part of the sub-air chamber member 10, corresponding to the head part 26a of the air valve 26, and the head part 26a is fitted into the recess via an adhesive material. The mounting structure thus configured makes it possible to omit the bracket 23 described above and the support member 20 described above.

Although embodiments of the present invention have been described and illustrated in detail, the disclosed embodiments are made for purposes of illustration and example only and not limitation. The scope of the present invention should be interpreted by terms of the appended claims.

### DESCRIPTION OF REFERENCE SIGNS

1: Vehicle wheel; 9: Tire air chamber; 10: Sub-air chamber member; 11: Rim; 11c: Well part; 11d: Outer circumferential surface; 12: Disk; 13: Main body; 14: Edge; 15: Vertical wall; 16: Partition wall; 18: Tubular body; 18a: Communication hole; 20: Support member; 21: Bead seat; 22: Rim flange; 23: Bracket; 23a: Translation part; 23b: Base end part; 23c: Leg part; 24: Gripping part; 24b: Locking hole; 25: Nail plate; 25a: Upper plate; 25b: Bottom plate; 25c: Side plate; 26: Air valve; 26a: Head part of air valve; 27: Valve inserting hole; 28: Overhanging part; 33: Bridge; 33a: Upper side connecting part; 33b: Lower side connecting part; 34: Base plate; 35: Upper side extending plate; 36: Lower side extending plate; 37: Band-shaped member; SC: Sub-air chamber; X: Wheel circumferential direction; Y: Wheel width direction; Z: Wheel radial direction

What is claimed is:

1. A vehicle wheel comprising a sub-air chamber member serving as a Helmholtz resonator, wherein
the sub-air chamber member is disposed in a tire air chamber with being supported by an air valve.

2. The vehicle wheel according to claim 1, wherein
the sub-air chamber member is connected to the air valve via a bracket, and
the bracket is insert-molded in the sub-air chamber member.

3. The vehicle wheel according to claim 1, wherein
the sub-air chamber member is supported by the air valve via a support member, and
the support member supports the sub-air chamber member so as to surround circumference of the sub-air chamber member.

4. The vehicle wheel according to claim 1, wherein
the sub-air chamber member is supported by the air valve via a support member, and
the support member has a gripping part nearly of a channel shape that grips the sub-air chamber member.

5. The vehicle wheel according to claim 1, wherein
the sub-air chamber member allows an edge of the sub-air chamber member to be locked to a well part at an opposite side in a wheel width direction to the air valve.
